(19) United States
(12) Patent Application Publication
(10) Pub. No.: US 2016/0191434 A1
(43) Pub. Date: Jun. 30, 2016

(54) SYSTEM AND METHOD FOR IMPROVED CAPTURE, STORAGE, SEARCH, SELECTION AND DELIVERY OF IMAGES ACROSS A COMMUNICATIONS NETWORK

(71) Applicant: Blue Yonder Labs LLC, Boerne, TX (US)

(72) Inventor: Rodney Rice, Boerne, TX (US)

(73) Assignee: BLUE YONDER LABS LLC, Boerne, TX (US)

(21) Appl. No.: 14/946,798

(22) Filed: Nov. 20, 2015

Related U.S. Application Data
(60) Provisional application No. 62/096,570, filed on Dec. 24, 2014.

(51) Int. Cl. H04L 12/58; G06F 17/30; H04L 29/08; G06K 9/00; H04N 7/18

(52) U.S. Cl. CPC H04L 51/10; G06K 9/00228; H04N 7/183; H04L 67/306; H04L 67/10; H04L 67/18; H04L 51/36; H04L 51/32; H04L 51/38; G06F 17/30864; G06F 17/30277

(57) ABSTRACT

The present invention generally relates to a system, implemented over a communications network, enabling system users (“Users”) to view and obtain photographs and videos (“Images”) of Users, to direct the taking of Images by such Users and to enable Users to procure Images, including digital Images as well as physical prints and products, and to provide such Images to Users. The system allows Users to easily view and procure Images taken by cameras operated by venues, independent Photographers or other people in the same location. The system allows Users to easily procure all the Images taken by others which contain the faces of persons indicated as “of interest” (e.g., themselves, family, friends, colleagues, celebrities, etc.). The present invention is directed to Image capture and delivery and embodies a core set of system mechanisms and functionalities which are employed across several different use case scenarios, specified in greater detail herein.

### CROSS REFERENCE TO RELATED U.S. PATENT APPLICATIONS

This application is a non-provisional of, and claims the benefit under 35 U.S.C. §119(e) of the earlier filing date of U.S. Provisional Application Ser. No. 62/096,570, filed on Dec. 24, 2014, which is hereby incorporated in entirety by reference.

### FIELD OF INVENTION

The present invention generally relates to a system, potentially implemented remotely over a communications network, enabling users of the system (“Users”) to receive and view photographs and videos (“Images”) of Users, to direct the taking of Images by such Users and to enable Users to procure Images, including digital Images as well as physical prints and products, and to provide such Images to Users.

### BACKGROUND

According to the Cisco Visual Networking Index, the number of mobile-connected devices exceeded the world population at the end of 2014, and by the end of 2019 there will be more than 10 billion mobile-connected devices. In Super Bowl 2011, there was 177 GB of network data usage, equivalent to 500,000 social media posts with photos, which increased by almost 4 times to 624 GB, equivalent to 1.8 million social media posts with photos in 2014.

Cameras used to capture Images may be wifi or bluetooth enabled or otherwise connect directly to the internet or other communications networks and be configured to send and receive data via such connections. In the US alone, tens of thousands of professional photographers and videographers (“Photogs”) and tens of millions of amateur Photogs capture hundreds of billions of potentially valuable Images every year.

On the professional side, often the Images are captured by an unmanned camera. As of yet, no truly efficient solution has been developed for Users to find, view and procure such Images. Frequently, there is no direct relationship between the Photog and the Users at the time the Images are captured. Many Images are not currently accessible remotely and, if available at all, existing methods for viewing and procuring Images often involve waiting in queues and establishing a direct financial relationship with the Photog or venue.

These Images are often captured in public venues and the User may not even know that a Photog has captured a particular Image let alone have access to an easy system or method for procuring these Images. Whether filming or photographing school events, sporting events, concerts, festivals, parties, galas, charity events, vacation cruises, weddings, resorts, tourism sites, amusement parks, theme parks, zoos, museums, camps, or any other venue, people whose Images have been captured at these events have not readily been able to locate, view and procure such Images.

Both conventional and modern systems and methods designed to provide solutions to this market problem have inherent shortfalls and inefficiencies. But given the pervasive nature of online culture and the nearly ubiquitous use of the internet, smartphones, tablets and apps, prospective customers desire the ability to immediately locate and procure Images captured at such events.

Historically, professional Photogs have captured and sold Images to participants in various public venues. However, these systems have typically involved a proactive action by the User (e.g., the person whose image has been captured) to locate such Images by searching monitor-displayed Images viewed on-site or over the internet, with significant time latency, or via physical proofs. These historical models often require viewing many captured Images in order to find relatively few out of the hundreds or thousands of Images taken, which amounts to the proverbial search for “a needle in a haystack”.

Further, traditional systems and methods often involve printing a large number of photographs, many more than are ultimately sold, and the sale is dependent upon the customer's viewing and agreeing to purchase the photograph displayed after the event. Certain more advanced methods may employ RFID to narrow the Images searched to those matching a person of interest, but require these methods require the person of interest to wear an RFID tag. Further, systems that employ RFID tags incur additional time, cost and effort (e.g., at least to the extent related to wearing a tag).

In addition, although facial recognition software is known, and can be trained to find a particular face and to group Images by recognized faces there is at present there no effective means for notifying customers of Images in which they appear. What's not currently available is a system which allows the consumer to search image databases based on unique geolocation, temporal and event codes associated with the Images and Users.

In the professional market, the conventional approaches typically involve lots of breakage, which has led to a significant fall off between desire to procure and/or purchase such Images and the number of Images actually distributed or sold. With amateurs, Photogs must either engage in the tedious task of manually curating and disseminating the Images, or more recently they post them to a cloud storage location and each consumer must obtain access and weed through the multitude of Images. Each layer of increased complexity for a prospective customer to initiate and complete a transaction to procure desired Images discourages more potential customers and corresponding transactions.

For instance, when customers do not receive Images or notifications of Images in a timely manner, but are instead required to proactively call or make an email request to receive Images or if the Images are held in an online repository (often including hundreds of thousands of Images) that must be proactively visited and searched to discover Images in which they are present, some potential customers will not be sufficiently motivated to initiate contact or to visit the online repository and search Images.

Further, when Images are not uploaded and made immediately available for search, even more potential customers will lack sufficient motivation to re-visit the online repository after the Images have been uploaded. Moreover, the customer must view the plurality of Images taken by the Photog with no ability to target only the content the customer is in.

Further, a customer may desire a photograph to be taken at a time when a Photog is not in the vicinity. Another problematic difficulty with traditional photography and videography is that in general there is no convenient system available wherein the Photog can themselves impromptu be included in the picture.

Based on the social media trend known as “selfies”, or self-taken photos, it is clear that people want an easy convenient method to take photos and videos of themselves and their companions, especially at large social gatherings. However, holding a camera or smartphone out at arm's length, or even at the end of a selfie stick, has drawbacks, especially regarding the ability to easily and adequately control the various aspects of the image capture.

Therefore, it is desirable to provide improved systems and methods for more effective capture, matching and delivery of Images to customers, on demand, with the capability of remote ordering and payment, in some embodiments through proactive delivery of Images via personal display devices based on facial recognition. It is also desirable to provide improved systems and methods whereby the customer can be a subject of the image and control the timing and other parameters of such image capture.

### SUMMARY OF THE INVENTION

The following is a summary of the invention in order to provide a basic understanding of some aspects of the invention. This summary is not intended to identify all key or critical elements of the invention or to delineate the entire scope of the invention. Its sole purpose is to present some concepts of the invention in a simplified form as a prelude to the more detailed description that is presented later.

Reference throughout this specification to “one embodiment” or “an embodiment” means that a particular feature, structure, or characteristic described in connection with an embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

The system allows people who are videoed and photographed by cameras operated by venues, independent Photogs or other people in the same location to easily view and procure such Images. Using face recognition, the system allows Users to easily procure all the Images taken by others which contain the faces of persons indicated as “of interest” (e.g., themselves, family, friends, colleagues, celebrities, etc.). The present invention is directed to Image capture and delivery and embodies a core set of system mechanisms and functionalities which are employed across several different use case scenarios, specified in greater detail herein.

In one embodiment the system is configured to capture, store, search, select and deliver selected Images to system Users, and the system comprises several elements including but not limited to 1) server machines, including processors and on-board non-transitory computer-readable media, that are connected to a communications network and operating as a backend server system; 2) imaging devices having removable non-transitory computer-readable media and/or a direct or indirect data connection to the communications network, wherein the imaging devices capture Images and may store the Images on the removable non-transitory computer-readable media or transmit the Images via the data connection; 3) User digital profiles containing User photographs and stored in non-transitory computer-readable media contained on the server machines; 4) a database of captured Images stored in the non-transitory computer-readable media contained on the server machines; and 5) computer readable instructions stored in the non-transitory computer-readable media contained on the server machines, which, when executed on a processor perform the steps, comprising: (i) assigning a unique catalog identifier (“UCI”; including but not limited to an event code, username, album code, location code or time code) to each captured image; (ii) generating a digital profile for persons of interest based on information and test Images input to the backend server system and information and test Images gathered by the backend server system; (iii) assigning UCI to the digital profiles based on information automatically generated by a location aware device and information input to the backend server system; (iv) inputting Images captured by the imaging devices into the database of captured Images; (v) restricting the database of captured Images based on correlation between UCIs assigned to the captured Images and to the digital profile for a person of interest; (vi) performing a facial recognition comparison search on the captured Images contained in the restricted database using test Images contained in a digital profile and identifying captured Images as Images of interest, based on positive facial recognition matches; (vii) delivering Images of interest to User accounts, including without limitation texting accounts, cable and satellite television accounts, web, mobile and personal computer application accounts, and email, social network and social media accounts.

In another embodiment the system comprises several elements including but not limited to 1) server machines, including processors and on-board non-transitory computer-readable media, that are connected to a communications network and operating as a backend server system; 2) imaging devices having unique identifiers and a direct or indirect data connection to the communications network, wherein the imaging devices capture Images and may transmit the Images via the data connection; 3) display devices having unique identifiers, and/or non-transitory computer readable media and a data connection to the communications network; and 4) computer readable instructions stored in the non-transitory computer-readable media contained on the server machines, which, when executed on a processor perform the steps, comprising: (i) operating control over specific imaging devices, wherein the backend server system is configured to identify and control specific imaging devices using their unique identifiers; (ii) receiving requests from User accounts and display devices associated with a User account, including at least User account identity, display device unique identifiers and a location automatically generated by a location aware device or a location input by a User, to capture Images and deliver captured Images; (iii) capturing Images by the imaging devices in accordance with the requests received; and (iv) delivering captured Images to the User accounts, and display devices associated with the User accounts, wherein the User accounts and associated display devices are configured to receive Images via a data connection, display the received Images and to store the received Images in the non-transitory computer readable medium.

In a further embodiment, the instructions loaded on the non-transitory computer readable media may additionally include the steps of: (v) collecting and providing to the backend server system, User accounts and associated display devices, sets of information related to specific imaging devices including but not limited to live streams of captured Images, imaging device unique identifiers, technical specifications and capabilities, location information, including but not limited to gps location, relative location, seat number, physical address and room identifier, status information, including but not limited to whether the imaging device is mobile or stationary, and local environmental data; (vi) collecting and providing to the backend server system, imaging devices, User accounts and associated display devices sets of smart cue information including without limitation face detection, size of a detected face, distance and direction of a detected face to an imaging device, position and orientation of a detected face relative to an imaging device, number of pixels between subject faces, recognition of subject faces, recognition of subject surroundings, User account identity, account status, number of likes or followers, frequency of account use, quality of account content, the unique identifier of a display device associated with a User account, placement of a display device on a person, and location of a subject or display device including without limitation a gps location, a relative location, a seat number, a physical address, a room number, and a distance and direction of a subject or display device relative to imaging devices, as determined by information automatically generated by location aware devices and information input to the backend server system; and (vii) capturing Images by the imaging devices in accordance with the requests received and operating control over parameters of image capture, including without limitation location, position, orientation, depth of field, field of view, focus, movement, angle, pan, tilt, zoom, framing and timing of image capture, based on smart cues.

In an additional embodiment, the instructions loaded on the non-transitory computer readable media may additionally include the steps of: (viii) scheduling image capture queues for specific imaging devices; (ix) establishing prioritization schemes for the order of the scheduled image capture queues based on the smart cues and sets of information; (x) collecting and providing to the backend server system, User accounts and associated display devices sets of information related to specific imaging devices, further including but not limited to the number of reservations in an image capture queue; (xi) receiving requests from User accounts and associated display devices to reserve places in the image capture queues; (xii) reserving a place in the scheduled image capture queues in accordance with the requests received and the established prioritization schemes; (xiii) capturing Images in accordance with the scheduled image capture queues; (xiv) delivering captured Images to the User accounts and associated display devices.

In another embodiment, the instructions loaded on the non-transitory computer readable media may additionally include the steps of: (v) receiving requests to control imaging devices, capture Images and deliver captured Images from User accounts and associated display devices, wherein the request includes at least a User account identity, display device unique identifiers, and a location automatically generated by a location aware device or a location input by a User; (vi) selecting specific imaging devices for control by the User accounts and associated display devices; (vii) sending to User accounts and associated display devices the unique identifiers of the specific imaging devices selected for control and permission to control the specific imaging devices; (viii) enabling User operated control over the specific imaging devices and parameters of image capture via imaging device control signals, generated by and received from the User accounts and associated display devices; and (ix) sending to the User accounts and associated display devices captured Images, wherein the User accounts and associated display devices receive Images via a data connection, display the received Images and to store the received Images in the non-transitory computer readable medium.

In a further embodiment, the instructions loaded on the non-transitory computer readable media may additionally include the steps of: (x) scheduling imaging device control queues for specific imaging devices; (xi) establishing prioritization schemes for the order of the scheduled imaging device control queues based the smart cues and sets of information; (xii) collecting and providing to the backend server system, User accounts and associated display devices sets of information related to specific imaging devices, further including but not limited to the number of reservations in an imaging device control queue; (xiii) receiving requests from User accounts and associated display devices to reserve a place in an imaging device control queue; (xiv) reserving a place in the scheduled imaging device control queues in accordance with the requests received and the established prioritization schemes; (xv) enabling User operated control over the specific imaging devices in accordance with the scheduled imaging device control queues; (xvi) delivering captured Images to the User accounts and associated display devices.

In an additional embodiment, the system comprises: 1) imaging devices, having non-transitory computer readable media, processors and/or a direct or indirect data connection to a communications network, wherein the imaging devices capture Images and may transmit the Images via the data connection; 2) display devices, having a unique identifier, non-transitory computer readable media and a data connection to the communications network; 3) wherein the non-transitory computer-readable media contained in the imaging devices have instructions loaded thereon that, when executed on a processor, perform the steps comprising: (i) operating control over specific imaging devices; (ii) receiving requests from display devices, to capture Images and deliver captured Images, wherein the request includes at least the unique identifier of the display device; (iii) capturing Images by the imaging devices in accordance with the requests received; and (iv) delivering captured Images to the display devices, wherein the display devices receive Images via a data connection, display the received Images and store the received Images in the non-transitory computer readable medium.

In another embodiment, the instructions loaded on the non-transitory computer readable media may additionally include the steps of: (v) receiving requests from the display devices to control the imaging device, capture Images and deliver captured Images, wherein the request includes at least the unique identifier of the display device; (vi) sending to display devices permission to control the imaging device; (vii) enabling User operated control over the imaging device and parameters of image capture via imaging device control signals, generated by and received from the display devices; and (viii) sending to the display devices Images captured by the imaging device, wherein the display devices receive Images via a data connection, display the received Images and store the received Images in the non-transitory computer readable medium.

In a further embodiment, the image capture and delivery system comprises: 1) server machines, including processors and on-board non-transitory computer-readable media, that are connected to a communications network and operating as a backend server system; 2) imaging devices having removable non-transitory computer-readable media and/or a direct or indirect data connection to the communications network, wherein the imaging devices capture Images and may store the Images on the removable non-transitory computer-readable media or transmit the Images via the data connection; 3) display devices having unique identifiers, and/or non-transitory computer readable media and a data connection to the communications network; and 4) a database of captured Images stored in the non-transitory computer-readable media contained on the server machines; and 5) computer readable instructions stored in the non-transitory computer-readable media contained on the server machines, which, when executed on a processor perform the steps, comprising: (i) assigning a unique character code (“UCC”) to each captured image; (ii) sending to display devices image proofs and an offer to deliver the Images contained in the proofs, including at least the image UCCs; (iii) receiving an acceptance of the offer to deliver the Images, including at least the image UCCs and a UCI, sent via a User account, a texting, account, cable and satellite television accounts, web, mobile and personal computer application accounts, email, social network and social media accounts; and (iv) delivering a selected image to the User via a User account, a texting account, cable and satellite television accounts, web, mobile and personal computer application accounts, email, social network and social media accounts.

### BRIEF DESCRIPTION OF THE FIGURES

Non-limiting and non-exhaustive features will be described with reference to the following figures, wherein like reference numerals refer to like parts throughout the various figures. The figures below were not intended to be drawn to any precise scale with respect to size, angular relationship, or relative position.

FIG. 1 is a system diagram depicting the various components of the system.

FIG. 2 is a flow diagram depicting the steps performed by an embodiment of the system.

FIG. 3 is a flow diagram depicting the steps performed by another embodiment of the system.

FIG. 4 is a flow diagram depicting the steps performed by an additional embodiment of the system.

FIG. 5 is a flow diagram depicting the steps performed by another additional embodiment of the system.

FIG. 6 is a flow diagram depicting the steps performed by a further embodiment of the system.

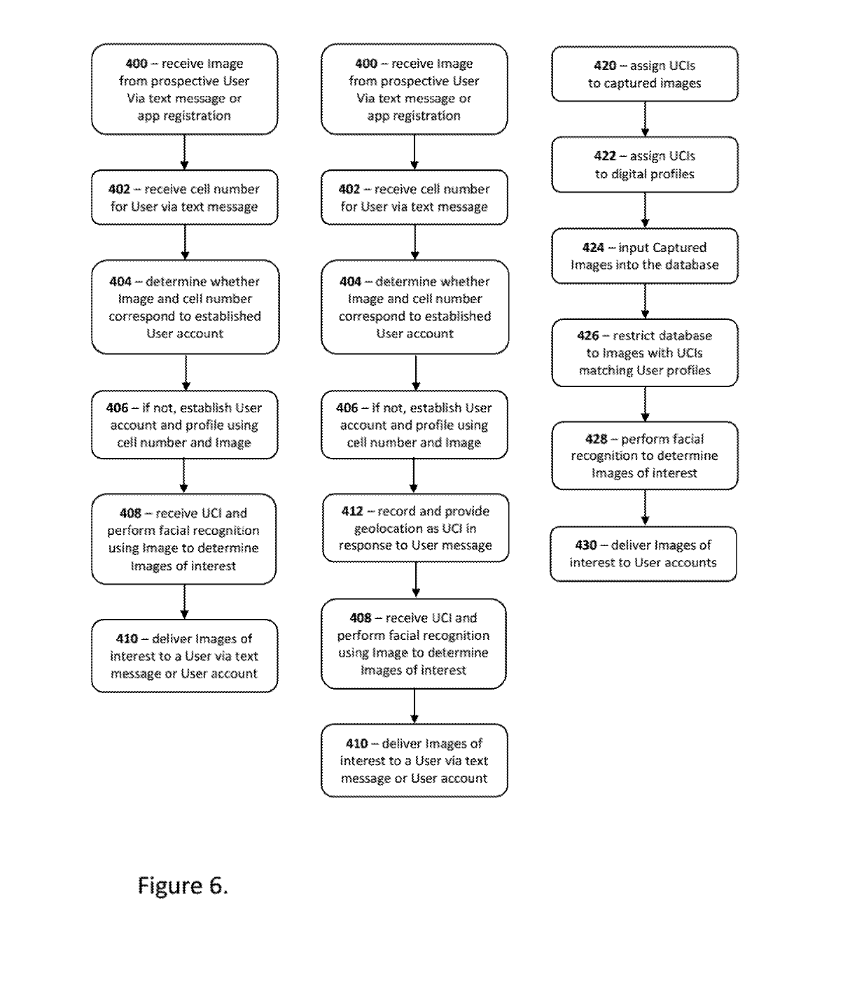

### DETAILED DESCRIPTION

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof and the invention includes all such modifications.

The present invention presents a solution for providing acquisition, storage, analysis and distribution of Images to Users that is applicable not only to all professional and freelance Photogs but also to all amateur Photogs and the general public, the largest creator by far of video and photographic content.

Events of interest may include but are not limited to school events, sporting events, concerts, festivals, parties, galas, charity events, vacation cruises, weddings, resorts, tourism sites, amusement parks, theme parks, zoos, museums, camps, or any other venue. Citing professional sporting events as an example, fans attend stadiums and arenas to watch their favorite teams compete, and they often attend these events with friends, family, work colleagues, clients, etc.

Stadium cameras include but are not limited to cameras operated by media staff, venue camerapersons, and a backend server system. Such cameras may be fixed location cameras, fly by wire cameras and/or drone cameras, including but not limited to aerial drones. Most sports venues have large screen “jumbotrons” which show the game and stats as well as videos and still shots of the players, cheerleaders, performers and fans. The extremely high resolution cameras available at such venues take priceless Images of the fans, the sports figures and entertainers, and these photos and videos would be sought after by the fans were they easily obtainable.

These Images can amount to a fan's “Andy Warhol moment” in which they are viewed by tens of thousands of fans in the venue or millions via television. And because of the positioning of the cameras, these Images are captured at an angle and perspective not achievable by the fans themselves. However, today these videos and pictures are often merely fleeting moments. At present, the fans have no way to capture and hold onto these memories, memorialize them and share them with others.

Downloading individual applications for each venue, event or service provider is not a feasible solution for multiple reasons. First of all, storage memory on User smartphones would become flooded with “bloatware” that would ultimately impair smartphone performance. The instant invention represents a backend server platform capable of powering all current service providers in the event photos and video market space with facial recognition and online account and device application-based alerts and solicitations for purchase.

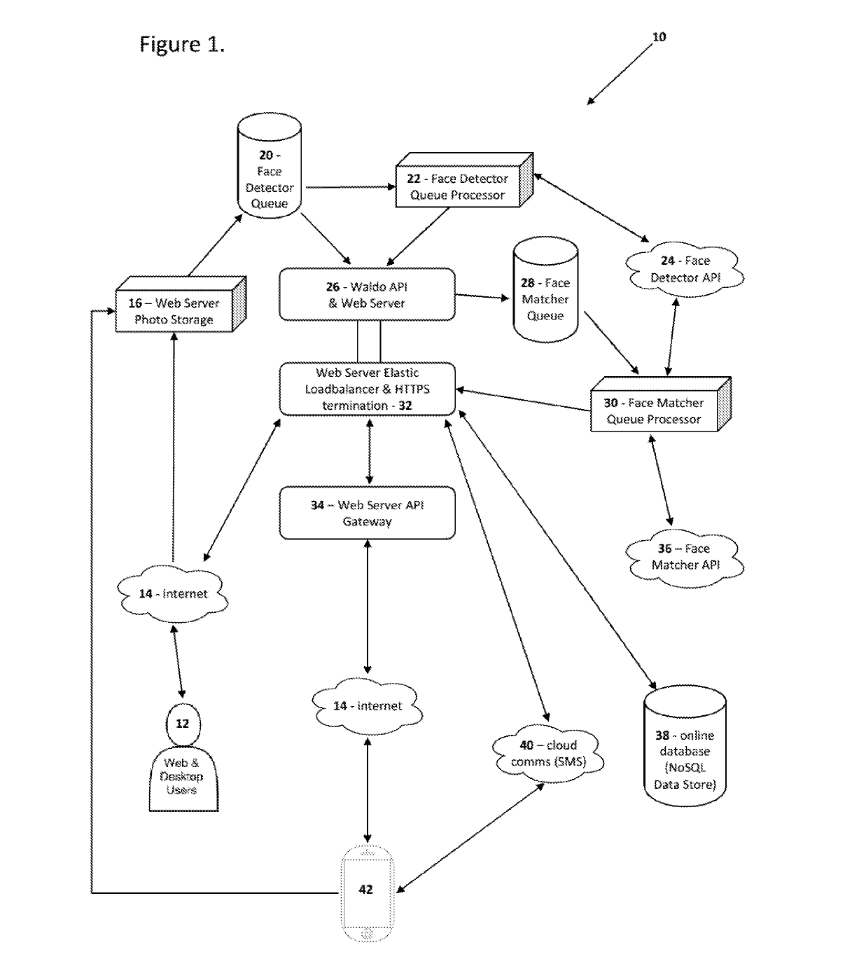

The server machines and backend server system of the present invention may comprise one or more of rackmount servers, desktop computer platforms, laptop computers, tablets, and smart phones. These computational devices may be operated as one or more standalone servers and/or an integrated backend distributed server system 26, for instance managed by a dynamic, elastic load balancer 32 and gateway application program interface 34, such as the AWS API gateway, as shown in FIG. 1. Specifically, Direct LTE provides the capacity for Users smartphones to operate as an integrated, distributed backend server system.

The invention comprises an online platform for viewing, selecting and obtaining photos and video taken by corporate service providers as well as the various “mom and pop” service providers currently operating in the event photos and video market space, the crowd (as uploaded via social media applications) and even the arena or stadium cameras, amusement park cameras and others. Current models practiced in the market, including picsolve and yourgameface.com, are inherently flawed because the breakage in contact with the customer is too significant.

Each layer of increased complexity for a prospective customer to initiate and complete a transaction to obtain desired Images discourages more potential customers and corresponding transactions. For instance, when Images are not proactively delivered to prospective customers, but the customers are instead required to visit a booth, proactively call or make an email request to receive Images if Images are rather held in an online repository that the customers must proactively visit in order to make a purchase, some potential customers will not be sufficiently motivated to initiate contact or to find the online repository website.

Further, when Images are not uploaded and made immediately available for selection and purchase by the potential customers, even more potential customers will lack sufficient motivation to revisit the online repository after the Images of interest have been uploaded. Moreover, traditional systems and methods typically involve either printing large amounts of photographs, many more than are ultimately sold, or displaying captured Images via monitors, with selection and sale being dependent upon customers' viewing and selecting Images displayed after the event or customers shifting through hundreds or thousands of Images in order to find the few which they are in. Often with today's solutions, the potential customer never even knows he or she were photographed or videoed and such Images are purchasable.

In summary, there are tens of thousands of companies aggregating many petabytes of content who are practicing the traditional systems and methods for capture, offer for sale, purchase and delivery of Images. These traditional systems and methods are high friction, “needle in a haystack” models based on market pull. A proactive “push” model implemented by a unified backend system and method for orchestrating capture, offer for sale, purchase and delivery of Images, with simple, stream-lined purchasing capability, will help improve the market and business efficiencies for the existing players who lack the resources to build such a backend system to support their businesses.

As depicted in FIG. 1, the present invention 10 is directed to image capture and delivery and embodies a core set of system mechanisms and functionalities which are employed across several different embodiments and use case scenarios. Core system mechanisms and functionalities across the various embodiments include a communication network, including the internet 14 or cloud based communications services 40, such as various texting and SMS services operated by and/or interfacing with a backend server system 26; imaging devices 42 configured to connect to the communication network, capture Images and to transmit the Images over the communications network; display devices 42 configured to connect to the communication network, to receive Images from the imaging devices through the communications network and to display the received Images to a User via application for mobile device 42 or web or desktop application 12. With the advent of modern smartphone technology, imaging devices 42 and display devices 42 within the system may often be one and the same device, though strictly speaking this is not a requirement.

Once Users have registered for an online account or downloaded a system application giving them access to the system backend, they can upload and share content, including information and Images, via the cloud and may be prompted to do so. Content may be uploaded directly to a database located on backend cloud servers, for instance an online database 38, such as an online NoSQL data store, and/or online photo store 16, such as the Amazon Web Simple Storage Service (S3) Photo Storage. Following upload of content, whether created by professionals, amateurs or “the crowd”, the backend server system may perform face detection and/or face recognition on captured Images.

FIG. 1 also shows that face detection may employ one or more of a face detector queue 20, a face detector queue processor 22 and the face detector API 24. Face recognition may employ one or more of a face matcher queue 28, a face matcher queue processor 30, a face detector API 24 and a face matcher API 36. Upon receiving a positive match in response to the facial recognition search, the system will alert Users regarding Images in which they are recognized or which contain other persons that such Users have indicated as persons of interest. Further, face recognition and face detection algorithms may be implemented as part of the integrated backed server system.

In addition, the system and method implemented by the instant invention presents the potential ability to leverage exposure to millions of prospective customers via captive audiences at big venues like arenas and stadiums, including the easy ability to draw in prospective Users with on-site promotions, etc., which Users' profile photos provide test Images for running facial recognition searches.

Within the contexts of the system and method of the present invention, a User may complete a registration for a User account, such as an online web account or a desktop application account, configured to implement the system, integrating one or more User devices (12 and 42) with the backend server system 26. The User may be prompted to register for the User account using any of the many various social networking platforms, or the User may provide registration details directly to the system—including at least cell number and a profile photo, e.g., a “selfie”.

Users may create User accounts simply by texting a selfie to a system texting account number. Further, Users may optionally include a unique catalog identifier (“UCI”), including but not limited to an event code, username, album code, location code or time code, in the system message to assist in appropriate parsing and restriction of captured image databases. In addition, Users may specify their desire to receive communications and alerts regarding or including positively matched Images via electronic messaging, such as email, text message, or in-application or in-account messages. In addition, the User may enable the use of location services to improve efficacy of face recognition matching.

Further, the system may acquire new Images through purchase, license or other transfer of content generated by professional content providers or through upload by system Users and the system may also use Images selected from a catalog of profile photos, Images obtained from various social network sites to run face recognition and find matching Images.

The system may further be configured to provide a location for a person of interest, and wherein the location is one or more of a GPS location, a relative location, and a seat number. Further, a User may select whether their presence can be indicated to other Users, groups of Users including family, friends and connections, and specific Users.

When new Images are uploaded into a database, having one or more assigned UCIs, the system matches them against the set of Users indicated (either manually or automatically) as within the specified proximity of the indicated geographic location (i.e., the User profile being tagged with a matching username, album, date, time, location and/or event code). Matching Images or alerts of matching Images may be sent to and viewed by Users via email, text message, in-application, or online web site account.

Users may purchase or procure Images by sending a text to a system cell number or texting account number with cell service provider direct billing, application, electronic payment via an integrated web site commerce platform or online account, credit card, bank debit account, paypal, e-wallet, etc. Further, Users may receive delivery of purchased Images via email, text message, application or website download, automatic or manual selection for posting directly to social media or by physical delivery.

In one embodiment the system is configured to acquire, store, search and select captured Images, and to deliver selected Images to system Users. The system of this embodiment comprises several elements including but not limited to server machines 26, including at least processors and on-board non-transitory computer-readable media among many other components, wherein these server machines are connected to a communications network and may operate as an integrated backend server system 32 and 34.

The system of this embodiment may also include imaging devices 42 that may have removable non-transitory computer-readable media and/or a direct or indirect data connection to the communications network 14, wherein the imaging devices are configured to capture Images and may store the Images on the removable non-transitory computer-readable media or transmit the Images via the data connection. Where imaging devices do not have a direct data connection to the communications network, they may store Images on removable non-transitory computer readable media configured to enable extraction of Images from the memory card and uploaded to the system via a computer or other device in data communication with the communications network.

The system of this embodiment may additionally include databases of captured Images 16 or 38 stored by the server machines in non-transitory computer-readable media and User digital profiles containing User photographs. Further, computer readable instructions stored in the non-transitory computer-readable media contained on the server machines 26, when executed on a processor, may perform one or more steps in sequence, in parallel or out of sequence.

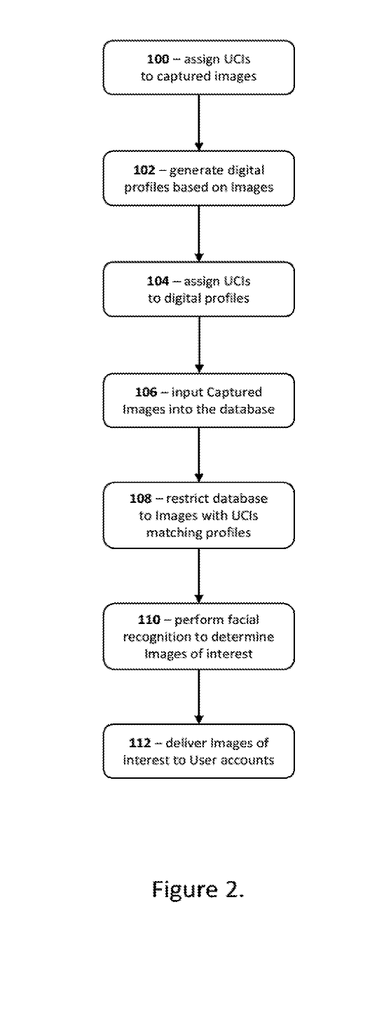

As depicted in FIG. 2, these steps may include 1) assignment of a UCI (e.g., an alphanumeric code) to each captured image 100, 2) generation and storage in an online database 38 of digital profiles for persons of interest based on information and test Images input to the backend server system 26 and information and test Images gathered by the backend server system 102, 3) assignment of a UCI to the digital profiles based on information automatically generated by a location aware device 42 and information input to the backend server system 104, 4) input of Images captured by imaging devices into the database 16 or 38 of captured Images 106, 5) restriction of the searchable database of captured Images based on correlation of UCIs assigned to the captured Images and to the digital profile for a person of interest 108, 6) performance of a facial recognition comparison search on the captured Images contained in the restricted database using test Images contained in a digital profile and identification of captured Images as Images of interest, based on positive facial recognition matches 110, and 7) distribution of Images of interest to User accounts, including without limitation texting accounts, cable and satellite television accounts, web, mobile and personal computer application accounts, and email, social network and social media accounts 112.

Further, the backend server system may be configured to recognize and store new Images of people and to build as large a database as possible for test Images of known persons for comparison with newly captured Images. To more accurately determine the subset of known-person test Images to use for comparison in performance of face recognition it is advantageous for the system to be able to determine whether a person for whom the system is performing face recognition was within range, i.e. within the same general vicinity or locality during the correct period of time, of the camera or imaging device that captured the Images on which the face recognition is being performed.

UCIs may be assigned to captured Images based on information encoded in the image by a smart imaging device, based on information attached to the image by a smart device connected to the imaging device or associated with the imaging device through an online or application based interface, or based on information manually attached to a captured image using an online or application based interface.

The steps performed by the instructions loaded on the non-transitory computer readable media, when executed on a processor, may also include: 8) extraction of a time code from an exchangeable image file format (“Exif”) image captured by an imaging device, 9) match the extracted time code with a location code provided by a location aware device located in the same place or in the same vicinity as the imaging device and indicated as such either by automatic detection and User input, assigning the matched location code to the captured Exif image.

The steps performed by the instructions loaded on the non-transitory computer readable media, when executed on a processor, may additionally include: 8) restriction of the database of captured Images based on face detection, i.e., detecting the mere presence of a face, the size of a detected face, a number of pixels contained in a detected face, the number of pixels between detected faces, a percentage of total pixels contained within a detected face, a distance of a detected face to the imaging device and an orientation of a detected face relative to the imaging device.

The steps performed by the instructions loaded on the non-transitory computer readable media, when executed on a processor, may further include: 8) restriction of the database of captured Images based on a position and an orientation and field of view of an imaging device relative to a position of a person of interest, as determined by information automatically generated by a location aware devices or input by a User.

When Users or other persons of interest are indicated as present at a particular event or place and time, the system is configured to automatically run face recognition comparisons on Images indicated as captured within a selected radius of the location and time window of the event. Most modern cameras, imaging devices, video and photographic equipment embed a geographic location signature and time stamp data into captured Images that may be used for such purposes. Alternatively, a Photog uploading video or photos can manually select a date time and place on which selected Images were captures.

In the near future, imaging devices will also be able to encode the orientation, or direction the device is facing, when the image is captured. Further, nearly all smartphones are capable of being location enabled, or periodically logging a User's geographic location. This location also comes with a time stamp. Consequently, the easiest method for the system of the present invention to most accurately determine corresponding sets of test Images and uploaded Images for performance of face recognition is through periodically logging the location, time and place of imaging devices and known persons, including Users, subjects of captured Images and Photogs capturing photographs and video Images.

Where there is a match within a certain radial distance between a location of a known person and content generated by a camera or other imaging device, the backend server system will consider the test image corresponding to the known person in conducting face recognition on the content generated by that camera or imaging device.

Furthermore, mere geographic coordinates will often be insufficient for the most accurate determination of which content to search and for which persons to perform face recognition on the Images. This is because there are often many buildings and rooms within the same geographic locale, and without a more detailed specification of User place, unnecessary data sets of test Images as well as video and photo content will potentially be utilized by the system in performing face recognition.

With the advent of the Internet of Things (IoT), Bluetooth beacons, wifi location services, etc., it is already possible to provide much more granular specificity than mere geographic coordinates regarding User place. The backend server system also takes place-specificity into account in determining the data sets of test Images and videos and photos for performing face recognition.

If a User or known person is offline or a Photog is using a camera or imaging device that is not enabled to encode geographic location in the captured Images, there are several alternative methods for determining the location and or place of the User. For instance, if a Photog is using a camera that, although wifi or Bluetooth enabled, is offline, the Photog may pair or tether the wifi/Bluetooth enabled camera to a wifi/Bluetooth enabled smartphone via an app-based interface in order to immediately upload and log precise location, time and place for the Images captured.

Further, if a Photog is using a camera that is offline or not enabled to encode geographic location in the captured Images, the Photog may use a smartphone or other online device to login to the app- or web site-based interface and indicate that they are taking photos or capturing video at their current location. Later, the Photog can upload the Images captured and either system may automatically correlate time stamping of Images with the location logging of the smartphone or the Photog may manually associate the Images with the session during which the photo and video capture was previously indicated using the app- or website-based interface. Alternatively, or where a User or known person is not in possession of a smartphone or other online device, information regarding the username, album, location, place, date, time and event may be manually entered at a later time using the app or website interface.

To perform facial recognition, the system software employs profile photos (“test Images”) uploaded to a User account via the website, app or text, to search a database of Images, collected at a specific venue, event, location or time, for positive matches against the test image or a set of test Images. When there is a match, the User is alerted via the app, website or text message and enabled to procure such image. The software of the system can mine Images on social media and send an alert to a User to notify them and provide an offer to deliver of selected Images.

The backend server system may further be configured to obtain one or more test Images of persons' faces via submission by a User through an application interface or by scraping the test Images from online websites, such as social networking websites, online news sources, and online criminal records, to perform face recognition on the captured video and still Images using the test Images.

The backend server system may further be configured to obtain test Images of persons' faces and to perform face recognition on the captured Images using the test Images and to deliver, via the display devices, Images captured including persons recognized and an alert notification regarding the presence of persons identified as of interest by a User.

The steps performed by the instructions loaded on the non-transitory computer readable media, when executed on a processor, may alternatively include: 8) input to a digital profile of test Images for a person of interest by scraping the test Image from an online website or receipt of a test Image from a User via a User account, text account, web, mobile and personal computer application accounts, and email, social network and social media account. The test image may preferably be captured by an imaging device associated with a User account.

The steps performed by the instructions loaded on the non-transitory computer readable media, when executed on a processor, may further include: 8) performance of face recognition on the captured Images further based on receiving a prompt from the User. The User prompt may include without limitation the texting of a test image to a system text number, texting a unique catalog identifier to a system text number, entering a unique catalog identifier into a User account, and scanning a quick response code into the system.

The steps performed by the instructions loaded on the non-transitory computer readable media, when executed on a processor, may further include: 8) delivery of a prompt to a User to instigate the User to provide a current test Image of the User. Triggering the issuance of such a prompt may be based on a geographic location, relative location, scheduled event, and 9) use of a current test image of the User to perform face, object and pattern recognition.

The steps performed by the instructions loaded on the non-transitory computer readable media, when executed on a processor, may also further include: 8) delivery of a prompt to a User to instigate the User to capture a set of expressive test Images representing various different facial expressions, and 9) use of an expressive test Images to perform face recognition.

Other systems allow Users to train their algorithms against faces tagged by Users. But the system of the present invention improves upon these systems by enabling the system to optimize the search performed by reducing the size of the database (of Images) to be searched by invoking facial recognition against sets of captured Images selected based on positive matches between User presence at a specific location or attendance at a particular venue or event, as recorded by a UCI, and a UCI assigned to a captured image.

The utility and efficiency of systems like the current invention can be greatly enhanced by the ability to use geolocation and geofencing to narrow the set of Images included in the database searched for face recognition matching and identification of subjects. The system utilizes User smart devices, and the clock and locations services embedded within such smart devices, to log locations and respective time records for Users.

In selecting content and sets of Images to include in a database of captured Images to be searched for facial recognition positive matches, the system software compares User time and location records to the time and location of the content submitted by Photogs. Further, the system software may run facial recognition searches only on sets of Images with UCIs matching the UCIs logged in User profiles.

The backend server in the this embodiment may further be configured to recognize persons based on factors including face recognition, identification of User devices, numbers on sports equipment, bib numbers or jersey numbers, jersey names, recognition of clothing color and patterns, contextual pattern recognition of surroundings, and persistent tracking of identified subjects whose faces may become obscured in subsequent Images, to deliver Images of persons recognized to Users who indicate the desire to acquire Images of the persons recognized via display devices and means such as the User application.

To perform face recognition on video content, it is especially important to integrate the capability for persistent identification of individuals through successive frames. In particular, this persistent identification can be initially based upon a confirmed recognition of a subject face integrated with additional parameters including but not limited to contextual pattern recognition to determine colors, patterns and other identifying features (including numbers and writing) of subject clothing or uniforms, subject body outline, size and proportions, and location surroundings.

Once catalogued, the additional parameters can be utilized to track subject body movement and maintain persistent identification of subjects of interest, even in the absence of a positive face recognition match. This capability is especially important to support persistent recognition of subjects engaged in physical activities whereby they are not posing for the camera but rather are engaged in rapid body motions and often with their face not positioned directly at the camera.

The steps performed by the instructions loaded on the non-transitory computer readable media, when executed on a processor, may further include: 8) recognition of persons of interest in captured Images based on subject face recognition, a unique identifier of a User device, a number on sports equipment, a bib number or a jersey number or jersey name, recognition of clothing color and patterns, contextual pattern recognition and persistent tracking of an identified subject whose face is or may become obscured in various subsequent Images, and 9) determination of a captured Image to be an Image of interest based on recognition of a person of interest.

In some cases, where the camera is not itself a smart, networked device, the time stamped location of the content may be derived via another networked device associated to the Photog such that when they upload the content from the non-networked camera the location information is pulled from the account and associated with the Images based on a time match. However, in the identification of subjects at a specific location, although the system will first rely on a database compiled of Images having assigned UCIs that match the UCIs assigned to User profiles, it will always be able to utilize the full database of known faces or particular subsets thereof for determining the identify of subjects who remain unidentified after searching the database subset of Users who have self-selected as present at a specific venue, event or other location.

In another embodiment the system comprises several elements including but not limited to server machines, including at least processors and on-board non-transitory computer-readable media, among many other components, wherein these server machines are connected to a communications network 14 and may operate as an integrated backend server system 26. The system of this embodiment may also include imaging devices 42 having unique identifiers and a direct or indirect data connection to the communications network, wherein the imaging devices are configured to capture Images and may transmit the Images via the data connection.

The system of this embodiment may additionally include display devices 42 having unique identifiers, and that may also have non-transitory computer-readable media and/or a direct or indirect data connection to the communications network. Display devices may include any device with a display screen capable of receiving, storing and/or displaying captured Images. With the advent of modern smart phones, these devices may comprise both imaging device and display device.

In this version of the system, Users may obtain access to control a mobile imaging device available at a venue by using an online web platform or an onboard device application interface. The User may complete registration for an application or online account configured to implement the system, integrating one or more User devices. Users may request to receive transmission of a video feed from one or more mobile imaging devices, display this video feed on a smart display device, such as a smartphone or tablet computer, and to control a specific imaging device of interest. Further, Users may then employ their smart display devices to operate control over parameters of image capture by the specific imaging device, including but not limited to location, position, orientation, depth of field, field of view, focus, movement, angle, pan, tilt, zoom, framing and timing of image capture.

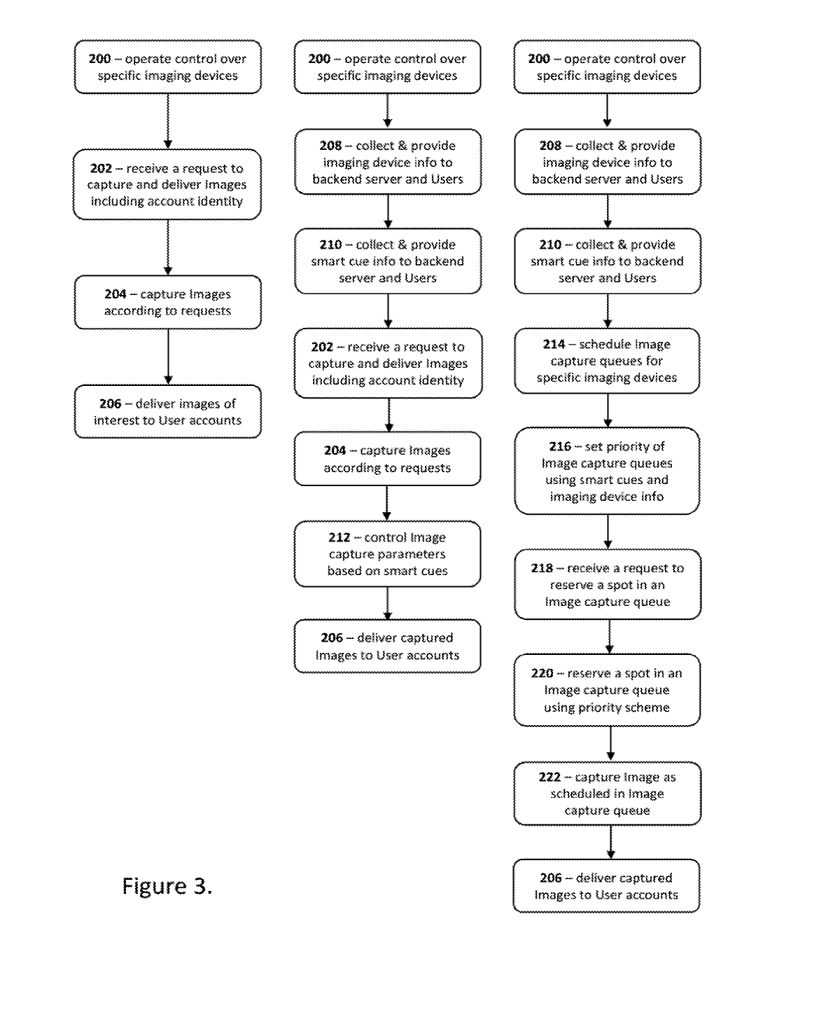

Further, computer readable instructions stored in the non-transitory computer-readable media contained on the server machines, when executed on a processor, may perform one or more steps in sequence, in parallel or out of sequence. These steps may include, as shown in FIG. 3, 1) operating control over specific imaging devices 42, wherein the backend server system is configured to identify and control specific imaging devices using their unique identifiers 200, 2) receiving requests, from User accounts and display devices associated with a User account, including at least the User account identity, the unique identifiers of the display devices, and a location automatically generated by a location aware device or a location input by a User, to capture Images and deliver captured Images 202, 3) capturing Images with the imaging device in accordance with the requests received 204, and 4) delivering captured Images to the User accounts, and display devices associated with the User accounts, wherein the User accounts and associated display devices are configured to receive Images via the data connection, display the received Images and store the received Images in the non-transitory computer readable medium 206.

In this version of the system, the Users are able to use the device app or web interface to request an imaging device, mobile or stationary, to take an image. The application may utilize a location, supplied by a GPS enabled or location aware smart device or manually input location (e.g., User seat location) in order to position a camera to capture an image (e.g., of the User who placed the request). The system software may utilize facial recognition to hone in on a subject and the optimal positioning for the image. Even further, the software of the system may utilize the position of a User's smart phone, tablet or network enabled device to optimize positioning and focus of the camera (e.g., a smartphone located in a front pant pocket facing forward and the camera can key onto this relative position to capture an optimal image of the User).

In an additional embodiment, the computer readable instructions, when executed on a processor, may perform, in sequence, in parallel or out of sequence, the additional steps of 5) collecting sets of information related to specific imaging devices including but not limited to live streams of captured Images, imaging device unique identifiers, technical specifications and capabilities, location information, including but not limited to gps location, relative location, seat number, physical address and room identifier, status information, including but not limited to whether the imaging device is mobile or stationary, and local environmental data 208, and 6) providing these sets of information to the backend server system, User accounts and associated display devices 208.

The steps performed by the computer readable instructions in this embodiment may further include 7) collecting sets of smart cue information including without limitation face detection, size of a detected face, distance and direction of a detected face to an imaging device, position and orientation of a detected face relative to an imaging device, number of pixels between subject faces, recognition of subject faces, recognition of subject surroundings, User account identity, account status (e.g., superuser status, season tickets holders, VIP status and recognized life events), number of likes or followers, frequency of account use, quality of account content, the unique identifier of a display device associated with a User account, placement of a display device on a person, and location of a subject or display device including without limitation one or more of a gps location, a relative location, a seat number, a physical address, a room number, and a distance and direction of a subject or display device relative to a one or more imaging devices, as determined by one or more of information automatically generated by one or more location aware devices and information input to the backend server system 210, and 8) providing these sets of smart cue information to the backend server system, imaging devices, User accounts and associated display devices 210.

This version of the system may further be configured to determine, identify and/or locate subjects of interest based on sets of smart cue information including but not limited to User app subscription level, number of likes or followers, frequency of use, quality of content or superuser status, season tickets holders, and recognized life events. The system may use optical means to collect additional smart cue information including but not limited to subject face detection, face recognition and subject location, including optical character recognition of a seat, row and number indicated on a ticket stub, an optical reading of a QR code or barcode.

Subject or smart device location may also be determined by manual entry of a subject location or seat section, row and number, GPS, radio frequency proximity and multi-angulated location for a display device. Determination of a relative location for a subject can be based on recognition of subject faces and local surroundings, including position and orientation of subject faces and number of pixels between subject faces.

Examples of “recognized life events” may include, but are not limited to, “my first concert”, “first game with my son”, “going to propose”, “family meetup at the playoffs”, “college friends reunion for the big game”, “out with my girlfriend”, “out with the boys”, “ladies night out”, etc. Further, the backend server system of the first embodiment may be configured to communicate the context-rich information regarding identification and location of subjects of interest to one or more imaging devices. This enables representation of “hotspots” and prioritization of image capture by the system and/or imaging device operators and/or transfer of control over imaging devices.

The final step performed by the computer readable medium in this embodiment may furthermore include 9) capturing Images by the imaging devices in accordance with the requests received and operating control over parameters of image capture, including without limitation location, position, orientation, depth of field, field of view, focus, movement, angle, pan, tilt, zoom, framing and timing of image capture, based on the collected sets of smart cue information 212. By providing the sets of smart cues to the backend server system, imaging devices, User accounts and associated display devices, the present invention enables the operation and control of imaging devices and prioritization of requests for capture of Images based on “heat maps” of User data, including identity, location and account status, among other factors.

In an additional alternative embodiment, the computer readable instructions, when executed on a processor, may perform, in sequence, in parallel or out of sequence, the additional steps of: 10) scheduling image capture queues for specific imaging devices 214, 11) establishing prioritization schemes for the order of the scheduled image capture queues based on the smart cues and sets of information 216, 12) receiving requests from User accounts and associated display devices to reserve places in the image capture queues 218, 13) reserving a place in the scheduled image capture queues in accordance with the requests received and the established prioritization schemes 220, 14) collecting and providing to the backend server system, User accounts and associated display devices sets of information related to specific imaging devices, further including but not limited to the number of reservations in an image capture queue 208, 15) capturing Images in accordance with the scheduled image capture queues 222, and 16) delivering captured Images to the User accounts and associated display devices 206.

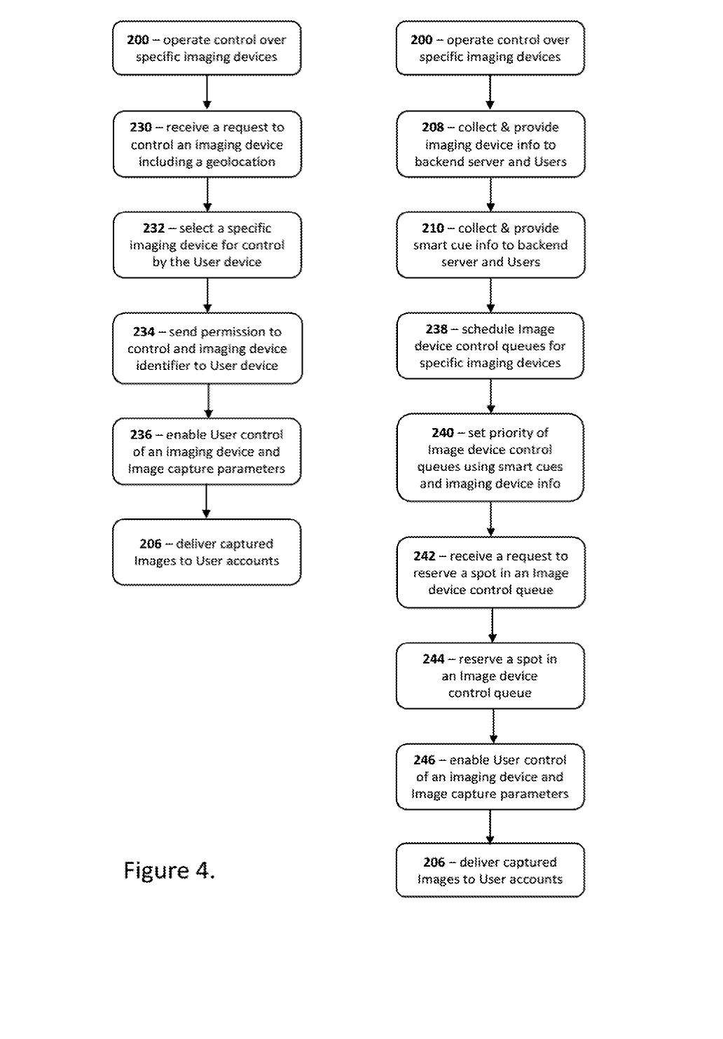

In a further embodiment, as shown in FIG. 4, the computer readable instructions, when executed on a processor, may perform, in sequence, in parallel or out of sequence, the additional steps of: 5) receiving requests, to control imaging devices, capture Images and deliver captured Images, from User accounts and display devices associated with a User account, wherein the requests include at least User account identity, display device unique identifiers and a location, either automatically generated by a location aware device or input by a User 230, 6) selecting specific imaging devices for control by the User accounts and associated display devices 232, 7) sending to User accounts and associated display devices permission to control the specific imaging devices selected for control and the unique identifiers of those specific imaging devices 234, 8) enabling User operated control over the specific imaging devices and parameters of image capture via imaging device control signals, generated by and received from the one or more User accounts and associated display devices 236, and 9) delivering captured Images to the User accounts and associated display devices, wherein the User accounts and associated display devices receive Images via a data connection, display the received Images and store the received Images in the non-transitory computer readable medium 206.

Further, the backend server system of this embodiment may be configured to queue requests for transmission and control over the imaging devices and to prioritize the requests based on parameters associated with each request, such as sets of information or sets of smart cues. The software of the system enables the User to view the camera's perspective via the app on their smart phone, tablet or other network-enabled device. Moreover the User may be able to request and operate control over the position, field of view and other aspects of image capture by the camera.

In a further alternative embodiment, the computer readable instructions, when executed on a processor, may perform, in sequence, in parallel or out of sequence, the additional steps of: 10) scheduling imaging device control queues for specific imaging devices 238, 11) establishing prioritization schemes for the order of the scheduled imaging device control queues based the smart cues and sets of information 240, 12) receiving requests from User accounts and associated display devices to reserve a place in an imaging device control queue 242, 13) reserving a place in the scheduled imaging device control queues in accordance with the requests received and the established prioritization schemes 244, 14) collecting and providing to the backend server system, User accounts and associated display devices sets of information related to specific imaging devices, further including but not limited to the number of reservations in an imaging device control queue 208, 15) enabling User operated control over the specific imaging devices in accordance with the scheduled imaging device control queues 246, 16) delivering captured Images to the User accounts and associated display devices 206.

In yet another embodiment, the system comprises several elements including but not limited to an imaging device, having a non-transitory computer readable media, processors and/or a direct or indirect data connection to a communications network. The imaging device captures Images and may transmit the Images via the data connection. The system further includes display devices, having a unique identifier, non-transitory computer readable media and a data connection to the communications network.

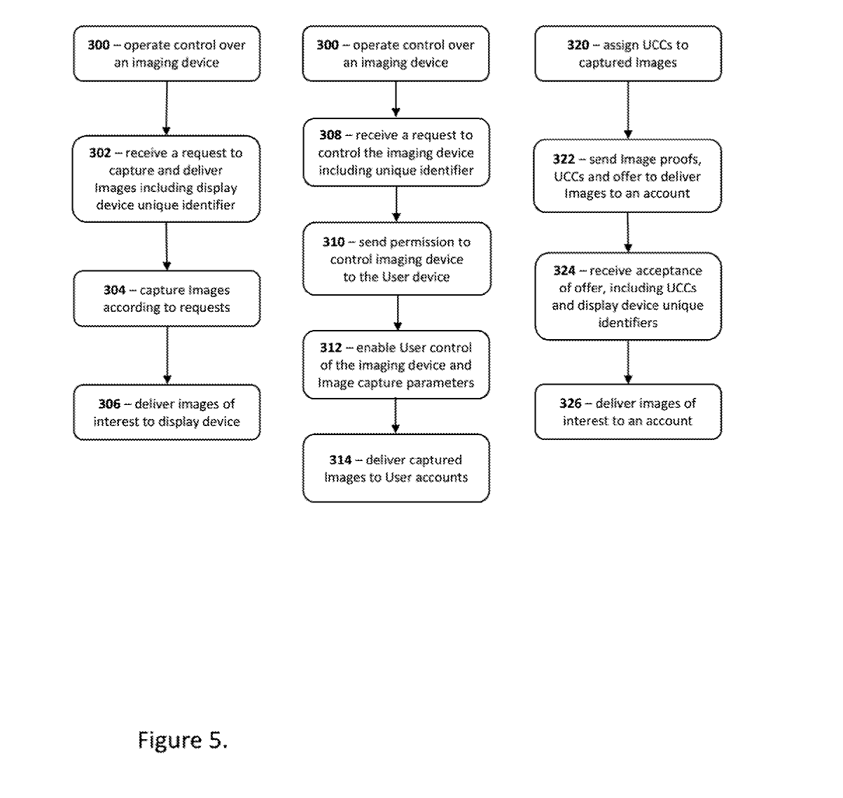

Further, as shown in FIG. 5, the non-transitory computer-readable media contained in the imaging device 42 has instructions loaded thereon that, when executed on a processor, perform the steps comprising: 1) operating control over the imaging device 300, 2) receiving requests from display devices, to capture Images and deliver captured Images, wherein the request includes at least the unique identifier of the display device 302, 3) capturing Images by the imaging devices in accordance with the requests received 304, and 4) delivering captured Images to the display devices, wherein the display devices receive Images via a data connection, display the received Images and store the received Images in the non-transitory computer readable medium 306.

In another alternative embodiment, the instructions loaded on the non-transitory computer readable media may additionally include the steps of: 5) receiving requests from the display devices 42 to control the imaging device, capture Images and deliver captured Images, wherein the request includes at least the unique identifier of the display device 308, 6) sending to display devices permission to control the imaging device 310, 7) enabling User operated control over the imaging device and parameters of image capture via imaging device control signals, generated by and received from the one or more display devices 312, and 8) delivering captured Images to the display devices, wherein the display devices are configured to receive Images via a data connection, display the received Images and store the received Images in the non-transitory computer readable medium 314.

In this version of the system, the integrated backend server 26 may operate control over the imaging devices and the parameters of image capture, including but not limited to location, position, orientation, depth of field, field of view, focus, movement, angle, pan, tilt, zoom, framing and timing of image capture by a specific imaging device based on smart cues, including but not limited to identification of a display device, location of a display device on a person, recognition of subject faces, position and orientation of subject faces and number of pixels between faces, and to communicate this information to one or more imaging devices. Additionally, the display devices may be configured to request transmission of, receive, store and display a video feed from one or more imaging devices and to request permission to and to operate control over an imaging device and the parameters of image capture; the backend server system further configured to queue requests for transmission and control over the imaging devices.

In yet a further embodiment, the system comprises several elements including but not limited to server machines, including processors and on-board non-transitory computer-readable media, among many other components, wherein these server machines are connected to a communications network and may operate as an integrated backend server system 26.

The system of this embodiment may also include imaging devices that may have removable non-transitory computer-readable media and/or a direct or indirect data connection to the communications network, wherein the imaging devices are configured to capture Images and may store the Images on the removable non-transitory computer-readable media or transmit the Images via the data connection. Where imaging devices do not have a direct data connection to the communications network, they may store Images on removable non-transitory computer readable media configured to enable extraction of Images from the memory card and uploaded to the system via a computer or other device in data communication with the communications network.

The system of this embodiment may additionally include display devices having unique identifiers, and that may also have non-transitory computer-readable media and/or a direct or indirect data connection to the communications network. Display devices may include any device with a display screen capable of receiving, storing and/or displaying captured Images, and smartphones often comprise both imaging and display devices.

The system of this embodiment may additionally include databases of captured Images stored by the server machines in non-transitory computer-readable media. Further, computer readable instructions stored in the non-transitory computer-readable media contained on the server machines, when executed on a processor, may perform one or more steps in sequence, in parallel or out of sequence.

These steps may include 1) assigning a unique character code (“UCC”) to each captured image 320, 2) sending to display devices image proofs and an offer to deliver to an account the Images contained in the proofs, including at least a UCC 322, 3) receiving an acceptance of the offer to deliver the Images, including at least the UCC assigned to an image and a display device unique identifier, sent via a User account, a texting account, cable and satellite television accounts, web, mobile and personal computer application accounts, email, social network and social media accounts 324, 4) delivering a selected image to the User via a User account, a texting account, cable and satellite television accounts, web, mobile and personal computer application accounts, email, social network and social media accounts 326.

In this embodiment, Users may view Images displayed on a display device with an associated unique character code (“UCC”) and may subsequently request to view a proof image by submitting the UCC to the backend server system. In this version of the system, display devices are specifically intended to include but are not limited to jumbotrons, handheld display devices, computer monitors, and television entertainment systems, and displayed Images may be accompanied by a UCC located in a corner or edge of the display screen (or other location), to enable viewers of the display device to procure or purchase a corresponding Image. The viewer may use the UCC to order such image via their smart phone or other internet-enabled or networked electronic device.

Further, the integrated backend server 26 is configured to assign a UCC to each image and to send image proofs to the display devices, including the UCCs and an offer to deliver the image contained in the proof. Further, the backend server is configured to receive an acceptance of the offer to deliver the image via means including a web commerce platform, a cable or satellite tv commerce platform, and text messaging using the UCC assigned to an image.

In this version of the system, Users may easily order the Images by simply texting the UCC to a system text address (which may include a short code), which may be provided on the display device. For the purposes of this application, texting shall be interpreted to include computer and cell phone electronic messaging, including electronic messaging, instant messaging, imessage, sms, mms, email and smtp.

Alternatively, a User may send a text message to the system text address, including a UCI and an attached image of the User or other person at the venue, event or other location. Subsequently, the system will search a database of captured Images with corresponding associated UCIs, for positive facial and pattern recognition matches. In addition, the UCC or UCI can be provided to the system via entry through an application or online portal.

The User may be charged for delivery of Images via means including the User application account, credit card, a checking or debit account, a paypal account, an e-wallet, a bitcoin or other e-currency transaction, a web commerce platform, a cable or satellite tv service provider account, a cellular service provider account. The image may then either be physically delivered to the User via a text message, a cable or satellite tv commerce platform, a web commerce platform, email, social network or social media account. This means that Images may be emailed or texted directly to the fan, posted to their social media accounts or uploaded to their User account.

In yet a further additional embodiment, the system comprises several elements including but not limited to server machines, including processors and on-board non-transitory computer-readable media, among many other components, wherein these server machines are connected to a communications network and may operate as an integrated backend server system 26.

The system of this embodiment may also include imaging devices that have a data connection to the communications network and display devices that have a data connection to the communications network, wherein the server machines, imaging devices and display devices are all integrated within a single device.

The system of this embodiment may additionally include databases of captured Images stored by the server machines in non-transitory computer-readable media. Further, computer readable instructions stored in the non-transitory computer-readable media contained on the server machines, when executed on a processor, may perform one or more steps in sequence, in parallel or out of sequence.

These steps may include 1) receiving an image from a prospective User via one or more of a text message or an application registration 400, 2) receiving a cell phone number for the User via text message 402, 3) determining whether the image and cell phone number received correspond to an established User account and User profile 404, 4) establishing a User account and User profile, including a username, using at least the image and cell phone number received, if one does not yet exist 406, 5) receiving one or more unique catalog identifiers and performing a facial recognition comparison search on the one or more databases using the image received and determining one or more captured Images to be Images of interest, based on a positive facial recognition match 408, and 6) delivering one or more Images of interest over the communications network to a User via one or more of text message and a User application account 410.

These steps may further include 7) recording and providing a geolocation of location aware devices as a unique catalog identifier in response to receiving a message from the User, including one or more of a voice message, an email message, a text message 412.

These steps may further include 8) assigning unique catalog identifiers to each captured image based on information automatically generated by a location aware device and information input to the backend server system 420, 9) assigning unique catalog identifiers to a User profiles based on information automatically generated by a location aware device and information input to the backend server system 422, 10) inputting Images captured by the imaging devices into the database of captured Images 424, 11) restricting the database of captured Images based on matching unique catalog identifiers between captured Images and User profiles 426, 12) performing a facial recognition comparison search on the restricted database using the image received and determining captured Images to be Images of interest, based on a positive facial recognition match 428, and 13) delivering Images of interest over the communications network to one or more User accounts, including without limitation text accounts, cable and satellite television accounts, web, mobile and personal computer application accounts, and email, social network and social media accounts 430.

It should be understood that, although certain specific embodiments have just been described, claimed subject matter is not intended to be limited in scope to any particular embodiment or implementation. For example, one embodiment may be in hardware, such as implemented on a device or combination of devices. Likewise, although claimed subject matter is not limited in scope in this respect, one embodiment may comprise one or more articles, such as a storage medium or storage media that may have stored thereon instructions capable of being executed by a specific or special purpose system or apparatus, for example, to result in performance of an embodiment of a method in accordance with claimed subject matter, such as one of the embodiments previously described, for example. However, claimed subject matter is, of course, not limited to one of the embodiments described necessarily. Furthermore, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, claimed subject matter is not limited in scope to this example.

In the preceding description, various aspects of claimed subject matter have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be under stood by one of ordinary skill were omitted or simplified so as not to obscure claimed subject matter. While certain features have been illustrated or described herein, many modifications, substitutions, changes, or equivalents may now occur to those skilled in the art. It is, therefore, to be understood that the appended claims are intended to cover all such modifications or changes as fall within the true spirit of claimed subject matter.

What is claimed is:

1. A computer-implemented system configured to enable the capture, storage, search, selection and delivery of selected Images to system Users, the computer-implemented system comprising:
one or more server machines, having a data connection to the communications network,
wherein the server machines are in data communication over the communications network and may operate as an integrated backend server system,
wherein the server machines contain one or more processors and one or more on-board non-transitory computer-readable media;
one or more imaging devices, having one or more of a removable non-transitory computer-readable media, a data connection to a communications network and a data connection to a computer having a data connection to the communications network,
wherein the imaging devices are configured to capture Images and to one or more of store Images on a removable non-transitory computer-readable media and transmit Images via a data connection;
one or more digital profiles corresponding to one or more persons of interest, each digital profile containing one or more test Images of the corresponding persons of interest, and
wherein the one or more digital profiles are stored in one or more non-transitory computer-readable media contained on one or more of the server machines; and
a database comprising Images captured by the one or more imaging devices,
wherein the database of captured Images is stored in one or more non-transitory computer-readable media contained on one or more of the server machines, and
wherein one or more of the non-transitory computer-readable media contained in the one or more server machines have instructions loaded thereon that, when executed on one or more of the processors, perform the following steps, two or more of which steps are performed in one or more of in-sequential order, out-of-sequential order and in parallel, comprising:
assigning one or more unique catalog indicators to each captured image based on one or more of information automatically generated by a location aware device and information input to the backend server system;
generating a digital profile for one or more persons of interest based on one or more of information and test Images input to the backend server system and information and test Images gathered by the backend server system;
assigning one or more unique catalog indicators to the digital profile for a person of interest based on one or more of information automatically generated by a location aware device and information input to the backend server system;
inputting Images captured by the one or more imaging devices into the database of captured Images;
restricting the database of captured Images based on correlation of one or more unique catalog identifiers assigned to the captured Images and to the digital profile for a person of interest;
performing a facial recognition comparison search on the captured Images contained in the restricted database using one or more test Images contained in a digital profile and determining one or more captured Images to be Images of interest, based on a facial recognition match;
delivering one or more Images of interest over the communications network to one or more User accounts, including without limitation one or more of texting accounts, cable and satellite television accounts, web, mobile and personal computer application accounts, and email, social network and social media accounts.

2. The system of claim 1, wherein the instructions loaded on the non-transitory computer readable media, when executed on a processor, further perform the steps of:
extracting at least a time code from an exchangeable image file format image captured by an imaging device;
correlating the extracted time code to a location code provided by a location aware device that has been indicated as one or more of at the same location and in the same vicinity as the imaging device by one or more of automatic detection and User input;
assigning the correlated location code to the captured image.

3. The system of claim 1, wherein the instructions loaded on the non-transitory computer readable media, when executed on a processor, further perform the step of:
restricting the database of captured Images based on one or more of face detection, size of a detected face, a number of pixels contained in a detected face, a percentage of total pixels contained within a detected face, a distance of a detected face to the imaging device and an orientation of a detected face relative to the imaging device.

4. The system of claim 1, wherein the instructions loaded on the non-transitory computer readable media, when executed on a processor, further perform the step of:
restricting the database of captured Images based on one or more of position, orientation and field of view of an imaging device relative to a position of a person of interest, as determined by one or more of information automatically generated by one or more location aware devices and information input to the backend server system.

5. The system of claim 1, wherein the instructions loaded on the non-transitory computer readable media, when executed on a processor, further perform the steps of:
performing the face recognition on the captured Images further based on receiving a prompt from the User, wherein the prompt may include without limitation one or more of texting a test image to a system text number, texting a unique catalog identifier to system text number, entering a unique catalog identifier into a User account, and scanning a quick response code into the system.

6. The system of claim 1, wherein the instructions loaded on the non-transitory computer readable media, when executed on a processor, further perform the steps of:
prompting a User for a current test image of the User based on one or more of a geographic location, relative location, scheduled event; and
using a current test image of the User for performing face, object and pattern recognition.

7. The system of claim 1, wherein the instructions loaded on the non-transitory computer readable media, when executed on a processor, further perform the steps of:
prompting a User to capture a set of expressive test Images representing various different facial expressions; and
using one or more of the expressive test Images to perform face recognition.

8. The system of claim 1, wherein the instructions loaded on the non-transitory computer readable media, when executed on a processor, further perform the steps of:
recognizing persons of interest in captured Images based on one or more of subject face recognition, a unique identifier of a User device, a number on sports equipment, a bib number or a jersey number or jersey name, recognition of clothing color and patterns, contextual pattern recognition and persistent tracking of an identified subject whose face is or may become obscured in various subsequent Images, and
determining one or more captured Images to be Images of interest, further based on recognition of a person of interest.

9. The system of claim 1, wherein the instructions loaded on the non-transitory computer readable media, when executed on a processor, further perform the steps of:
obtaining and inputting to a digital profile one or more test Images for a person of interest via one or more of gathering one or more test Images by scraping the test image from online web sites or apps and receiving one or more test Images via one or more of a User account, texting accounts, web, mobile and personal computer application accounts, and email, social network and social media accounts, wherein the test image may be captured by an imaging device associated with a User account.

10. A User-participatory image capture and delivery system comprising:
one or more server machines, having a data connection to a communications network,
wherein the server machines are in data communication over the communications network and may operate as an integrated backend server system,
wherein the server machines contain one or more processors and one or more on-board non-transitory computer-readable media;
one or more imaging devices, having a unique identifier and one or more of a data connection to the communications network and a data connection to a computer having a data connection to the communications network,
wherein the imaging devices are configured to capture Images and to transmit Images via a data connection;
one or more display devices, having a unique identifier, one or more non-transitory computer readable media and a data connection to the communications network;
wherein one or more of the non-transitory computer-readable media contained in the one or more server machines have instructions loaded thereon that, when executed on one or more of the processors, perform the following steps, two or more of which steps are performed in one or more of in-sequential order, out-of-sequential order and in parallel, comprising:
operating control over one or more specific imaging devices, wherein the backend server system is configured to control one or more specific imaging devices over the communications network using the unique identifiers of the specific imaging devices;
receiving one or more requests from one or more User accounts, and one or more display devices associated with a User account, to capture one or more Images and deliver captured Images, wherein the request includes at least a User account identity, the unique identifier of the display device associated with the User account, and one or more of a location automatically generated by a location aware device and a location input by a User;
capturing one or more Images by the one or more imaging devices in accordance with the one or more requests received; and
delivering one or more captured Images to the one or more User accounts, and one or more display devices associated with the User accounts, wherein the User accounts and associated display devices are configured to receive Images via a data connection, display the received Images and to store the received Images in the non-transitory computer readable medium.

11. The system of claim 10, wherein the instructions loaded on the non-transitory computer readable media, when executed on a processor, further perform the steps of:
collecting and providing to one or more of the backend server system, one or more User accounts and associated display devices, sets of information related to one or more specific imaging devices including but not limited to one or more of live streams of captured Images, the unique identifiers of the specific imaging devices, technical specifications and capabilities, location information, including but not limited to gps location, relative location, seat number, physical address and room identifier, status information, including but not limited to whether the imaging device is mobile or stationary, and local environmental data;
collecting and providing to one or more of the backend server system, one or more User accounts, and associated display devices, and one or more imaging devices sets of smart cue information including without limitation face detection, size of a detected face, distance and direction of a detected face to an imaging device, position and orientation of a detected face relative to an imaging device, number of pixels between subject faces, recognition of subject faces, recognition of subject surroundings, User account identity, account status, number of likes or followers, frequency of account use, quality of account content, the unique identifier of a display device associated with a User account, placement of a display device on a person, and location of a subject or display device including without limitation one or more of a gps location, a relative location, a seat number, a physical address, a room number, and a distance and direction of a subject or display device relative to a one or more imaging devices, as determined by one or more of information automatically generated by one or more location aware devices and information input to the backend server system; and
capturing one or more Images by the one or more imaging devices in accordance with the one or more requests received and operating control over parameters of image capture, including without limitation one or more of location, position, orientation, depth of field, field of view, focus, movement, angle, pan, tilt, zoom, framing and timing of image capture by the specific imaging device, based on one or more smart cues;
delivering one or more captured Images to the one or more User accounts, and associated display devices.

12. The system of claim 11, wherein the instructions loaded on the non-transitory computer readable media, when executed on a processor, further perform the steps of:
scheduling one or more image capture queues for the one or more specific imaging devices;
establishing prioritization schemes for the order of the one or more scheduled image capture queues based on one or more of the smart cues and sets of information;
collecting and providing to the backend server system and one or more User accounts, and one or more display devices associated with a User account, sets of information related to one or more specific imaging devices, further including but not limited to the number of reservations in an image capture queue;
receiving one or more requests from one or more User accounts and associated display devices to reserve a place in one or more image capture queues;
reserving a place in the one or more scheduled image capture queues in accordance with the one or more requests received and the established prioritization schemes;
capturing one or more Images in accordance with the one or more scheduled image capture queues;
delivering one or more captured Images to the one or more User accounts, and associated display devices.

13. The system of claim 10, wherein the instructions loaded on the non-transitory computer readable media, when executed on a processor, further perform the steps of:
receiving one or more requests from the one or more User accounts and associated display devices to control one or more imaging devices, capture Images and deliver one or more captured Images, wherein the request includes at least a User account identity, the unique identifier of the display device associated with the User account, and one or more of a location automatically generated by a location aware device and a location input by a User;
selecting one or more specific imaging devices for control by the one or more User accounts and associated display devices;
sending to one or more User accounts and associated display devices the unique identifiers of the specific imaging devices selected for control and permission to control the specific imaging devices;
enabling User operated control over the one or more specific imaging devices by sending to the specific imaging devices one or more imaging device control signals, generated by and received from the one or more User accounts and associated display devices;
enabling User operated control over one or more parameters of image capture by one or more specific imaging devices; and
sending to the one or more User accounts and associated display devices Images captured by the one or more specific imaging devices, wherein the User accounts and associated display devices are configured to receive Images via a data connection, display the received Images and to store the received Images in the non-transitory computer readable medium.

14. The system of claim 13, wherein the instructions loaded on the non-transitory computer readable media, when executed on a processor, further perform the steps of:
scheduling one or more imaging device control queues for the one or more specific imaging devices;
establishing prioritization schemes for the order of the one or more scheduled imaging device control queues based on one or more of the smart cues and sets of information;
collecting and providing to the backend server system and one or more User accounts, and one or more display devices associated with a User account, sets of information related to one or more specific imaging devices, further including but not limited to the number of reservations in an imaging device control queue;
receiving one or more requests from one or more User accounts and associated display devices to reserve a place in one or more imaging device control queues;
reserving a place in the one or more scheduled imaging device control queues in accordance with the one or more requests received and the established prioritization schemes;
enabling User operated control over the one or more specific imaging devices in accordance with the one or more scheduled imaging device control queues;
delivering one or more captured Images to the one or more User accounts, and associated display devices.

15. A User-participatory image capture and delivery system comprising:
an imaging device, having one or more non-transitory computer readable media, one or more processors and one or more of a data connection to a communications network and a data connection to a computer having a data connection to the communications network,
wherein the imaging devices are configured to capture Images and to transmit Images via a data connection;
one or more display devices, having a unique identifier, one or more non-transitory computer readable media and a data connection to the communications network;
wherein one or more of the non-transitory computer-readable media contained in the one or more imaging devices have instructions loaded thereon that, when executed on one or more of the processors, perform the following steps, two or more of which steps are performed in one or more of in-sequential order, out-of-sequential order and in parallel, comprising:
operating control over one or more specific imaging devices;
receiving one or more requests from one or more display devices, to capture one or more Images and deliver captured Images, wherein the request includes at least the unique identifier of the display device;
capturing one or more Images by the one or more imaging devices in accordance with the one or more requests received; and
delivering one or more captured Images to the one or more display devices, wherein the display devices are configured to receive Images via a data connection, display the received Images and to store the received Images in the non-transitory computer readable medium.

16. The system of claim 15, wherein the instructions loaded on the non-transitory computer readable media, when executed on a processor, further perform the steps of:
receiving one or more requests from the one or more display devices to control the imaging device, capture Images and deliver one or more captured Images, wherein the request includes at least the unique identifier of the display device;
sending to one or more display devices permission to control the imaging device;
enabling User operated control over the imaging device by sending to the specific imaging device one or more imaging device control signals, generated by and received from the one or more display devices;
enabling User operated control over one or more parameters of image capture by the imaging device; and
delivering to the one or more display devices Images captured by the imaging device, wherein the display devices are configured to receive Images via a data connection, display the received Images and to store the received Images in the non-transitory computer readable medium.

17. An image capture and delivery system comprising:
one or more server machines, having a data connection to a communications network,
wherein the server machines are in data communication over the communications network and may operate as an integrated backend server system,
wherein the server machines contain one or more processors and one or more on-board non-transitory computer-readable media;
one or more imaging devices, having one or more of a removable non-transitory computer-readable media, a data connection to the communications network and a data connection to a computer having a data connection to the communications network,
wherein the imaging devices are configured to capture Images and to one or more of store Images on a removable non-transitory computer-readable media and transmit Images via a data connection;
one or more display devices, having a unique identifier, one or more non-transitory computer readable media and a data connection to the communications network;
a database comprising Images captured by the one or more imaging devices,
wherein the database of captured Images is stored in one or more non-transitory computer-readable media contained on one or more of the server machines; and
wherein one or more of the non-transitory computer-readable media contained in the one or more server machines have instructions loaded thereon that, when executed on one or more of the processors, perform the following steps, two or more of which steps are performed in one or more of in-sequential order, out-of-sequential order and in parallel, comprising:
assigning a unique character code to each captured image,
sending to one or more display devices one or more image proofs and an offer to deliver the Images contained in the proofs, including at least the image unique character codes,
receiving an acceptance of the offer to deliver the Images, including at least the unique character code assigned to an image and one or more display device unique identifiers, sent via one or more of a User account, a texting, account, cable and satellite television accounts, web, mobile and personal computer application accounts, email, social network and social media accounts; and
delivering a selected image to the User via one or more of a User account, a texting account, cable and satellite television accounts, web, mobile and personal computer application accounts, email, social network and social media accounts.

18. A computer-implemented system configured to perform User registration and to enable User search and delivery to Users of selected Images, comprising:
one or more server machines, having a data connection to a communications network,
wherein the server machines are in data communication over the communications network and may operate as an integrated backend server system,
wherein the server machines contain one or more processors and one or more on-board non-transitory computer-readable media;
one or more imaging devices, having a data connection to the communications network;
one or more display devices, having a data connection to the communications network,
wherein one or more of the server machines, imaging devices and display devices may all be integrated into a single device;
one or more databases comprising Images captured by the one or more imaging devices,
wherein the database of captured Images is stored in one or more non-transitory computer-readable media contained on one or more of the server machines, and
wherein the one or more non-transitory computer-readable media contained in one or more server machines having one or more processors, the non-transitory computer readable media having executable instructions loaded thereon that, when executed by the one or more processors, perform the following steps, comprising:
receiving an image of a prospective User via one or more of a text message or an application registration;
receiving a cell phone number for the User via text message;
determining whether the image and cell phone number received correspond to an established User account and User profile;
establishing a User account and User profile, including a username, using at least the image and cell phone number received, if one does not yet exist;
receiving one or more unique catalog identifiers and performing a facial recognition comparison search on the one or more databases using the image received and determining one or more captured Images to be Images of interest, based on a positive facial recognition match;
delivering one or more Images of interest over the communications network to a User via one or more of text message and a User application account.

19. The system of claim 18, wherein the executable instructions loaded on the non-transitory computer readable media, when executed on a processor, further perform the steps of:
recording and providing a geolocation of a location aware devices as a unique catalog identifier in response to receiving a message from the User, including one or more of a voice message, an email message, a text message.

20. The system of claim 19, wherein the executable instructions loaded on the non-transitory computer readable media, when executed on a processor, further perform the steps of:
assigning one or more unique catalog identifiers to each captured image based on one or more of information automatically generated by a location aware device and information input to the backend server system;
assigning one or more unique catalog identifiers to a User profile based on one or more of information automatically generated by a location aware device and information input to the backend server system;
inputting Images captured by the one or more imaging devices into the database of captured Images;
restricting the database of captured Images based on unique catalog identifier correlations between captured Images and User profiles;
performing facial recognition comparison searches on restricted databases using the image received and determining one or more captured Images to be Images of interest, based on a positive facial recognition match;
delivering one or more Images of interest over the communications network to one or more User accounts, including without limitation one or more of texting accounts, cable and satellite television accounts, web, mobile and personal computer application accounts, and email, social network and social media accounts.
